(19) United States
(12) Patent Application Publication
(10) Pub. No.: US 2005/0138536 A1
(43) Pub. Date: Jun. 23, 2005

(54) Systems and methods for identifying similar bugs

(76) Inventors: Zachary Steven Smith, Fort Collins, CO (US); John Warren Maly, Laporte, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/712,568

(22) Filed: Nov. 13, 2003

(51) Int. Cl. G06F 11/00

(52) U.S. Cl. 714/799

(57) ABSTRACT

Disclosed are systems and method for identifying similar bugs. In one embodiment, a system and a method pertain to generating a database that contains database tokens that relate to identified bugs, generating input tokens associated with a bug in question, scanning the database for occurrences of the input tokens, and determining an overall probability as to whether the identified bugs are the same as the bug in question.

### BACKGROUND

Various errors may be identified during the design of a program or during software-based modeling of a computer component (e.g., processor) design. Such errors may result from glitches in the program code at issue, which are often referred to as program “bugs.” Therefore, when a program operator receives such an error, it is common for the operator to investigate the error to determine if it was caused by a program bug.

When a bug is discovered, it is further common to log its discovery in a bug database that is used to track bugs from their discovery to their resolution. Such a bug database may include multiple bug records, each identifying a bug that was discovered, the date and time when each entry in the bug record was made, the circumstances under which the bug caused errors, who is believed to be responsible for fixing the bug, and various information that describes the nature of the bug. In addition to the written description of the bug and the manner in which it was discovered, the bug record entries may include a failing results file that comprises the primary results (i.e., output) of a test case that was run. Such a file may be attached to the bug record.

In order to facilitate debugging of the program at issue, it is necessary to determine whether the discovered bug is a new bug or a bug that was identified earlier, and is therefore already logged in the bug database. Although the debugger or another human being can manually scan through the bug database to determine if a bug record already exists for the discovered bug, this process is inefficient and is highly susceptible to human error. For instance, it may be difficult to identify an already-recorded bug if the number of bugs contained in the bug database and/or the number of entries in the bug records are large.

### SUMMARY

Disclosed are systems and method for identifying similar bugs. In one embodiment, a system and a method pertain to generating a database that contains database tokens that relate to identified bugs, generating input tokens associated with a bug in question, scanning the database for occurrences of the input tokens, and determining an overall probability as to whether the identified bugs are the same as the bug in question.

### BRIEF DESCRIPTION OF THE DRAWINGS

The disclosed systems and methods can be better understood with reference to the following drawings.

FIG. 1 is a block diagram of an embodiment of a computer system in which the disclosed systems and methods can operate.

FIG. 2 is a flow diagram of an embodiment of a method for identifying similar bugs.

FIG. 3 is flow diagram of an embodiment of operation of a derivative database generator shown in FIG. 1 in generating a derivative database.

FIGS. 4A and 4B provide a flow diagram of an embodiment of operation of a similarity calculator shown in FIG. 1 in calculating a probability as to bugs already identified in the bug database as being the same as a bug in question using a derivative database.

FIG. 5A is table that conceptually illustrates the contents of a derivative database.

FIG. 5B is a table that conceptually illustrates the results of normalization of similarity probabilities as to particular input tokens.

FIG. 5C is a table that conceptually illustrates the results of scaling the results of FIG. 5B.

FIG. 6 is a flow diagram of an embodiment of a method of identifying similar bugs.

### DETAILED DESCRIPTION

Disclosed are systems and methods for identifying similar bugs to aid a user (e.g., debugger) in determining whether a bug in question is a new bug or a bug that has already been identified and, therefore, is logged in a bug database. In some embodiments, a system and method can be used to automatically generate a derivative database based upon information contained in a bug database, and automatically make a probability determination as to the likelihood that one or more bugs of the bug database are the same as a bug in question. In such a case, the user can be provided with information that the user can use to make his or her own determination as to whether the bug in question is a new or a previously-identified bug.

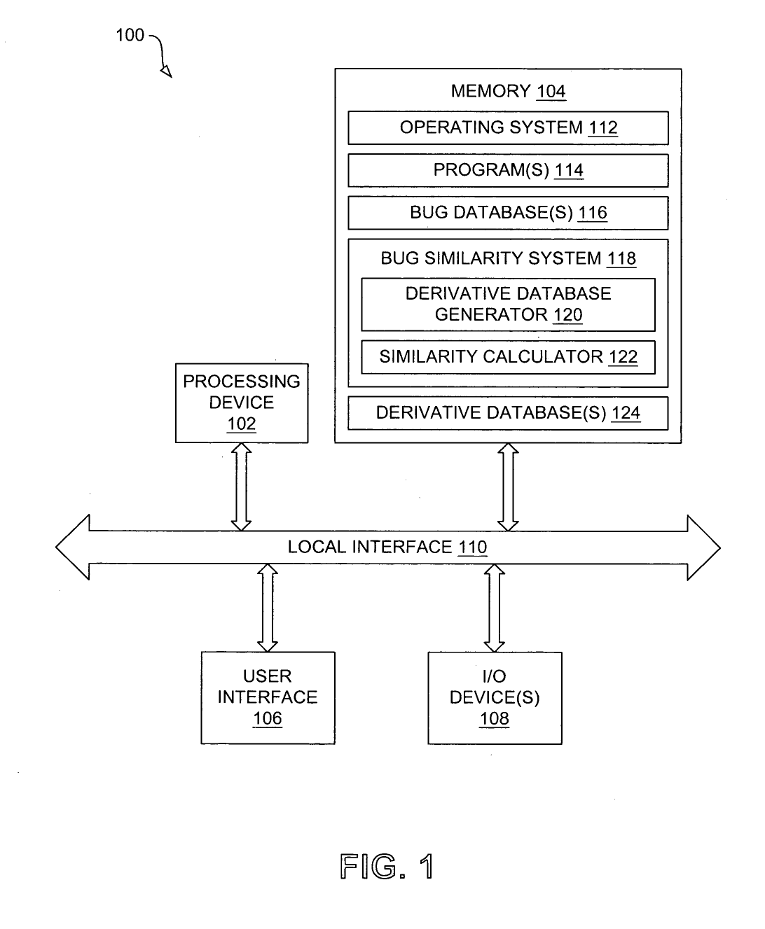

Referring first to FIG. 1, illustrated is an exemplary environment in which a bug similarity system and method may operate. More particularly, FIG. 1 is a block diagram of a computer system 100 in which a bug similarity system can execute and, therefore, a method for identifying similar bugs can be practiced. As indicated in FIG. 1, the computer system 100 includes a processing device 102, memory 104, at least one user interface device 106, and at least one input/output (I/O) device 108, each of which is connected to a local interface 110.

The processing device 102 can include a central processing unit (CPU) or an auxiliary processor among several processors associated with the computer system 100, or a semiconductor-based microprocessor (in the form of a microchip). The memory 104 includes any one or a combination of volatile memory elements (e.g., RAM) and nonvolatile memory elements (e.g., read only memory (ROM), hard disk, etc.).

The user interface device(s) 106 comprise the physical components with which a user (i.e., operator) interacts with the/computer system 100, such as a keyboard and mouse. The one or more I/O devices 108 are adapted to facilitate communication with other devices. By way of example, the I/O devices 108 include one or more of a universal serial bus (USB), a Firewire, or a small computer system interface (SCSI) connection component and/or network communication components such as a modem or a network card.

The memory 104 comprises various programs including an operating system 112 that controls the execution of other programs and provides scheduling, input-output control, file and data management, memory management, and communication control and related services. In addition to the operating system 112, the memory 104 comprises one or more programs 114 that may include bugs, and one or more bug databases 116 with which operators track the bugs discovered in those programs.

Further contained in the memory 104 is a bug similarity system 118 that is used to calculate probabilities as to whether a bug in question has been previously identified. As is discussed in greater detail below, the bug similarity system 118 includes a derivative database generator 120 that is configured to automatically generate one or more derivative databases 124 from the one or more bug databases 116, and a similarity calculator 122 that is configured to calculate the probability of one or more previously-identified bugs being the same bug as the bug in question.

Various programs (i.e., logic) have been described herein. Those programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

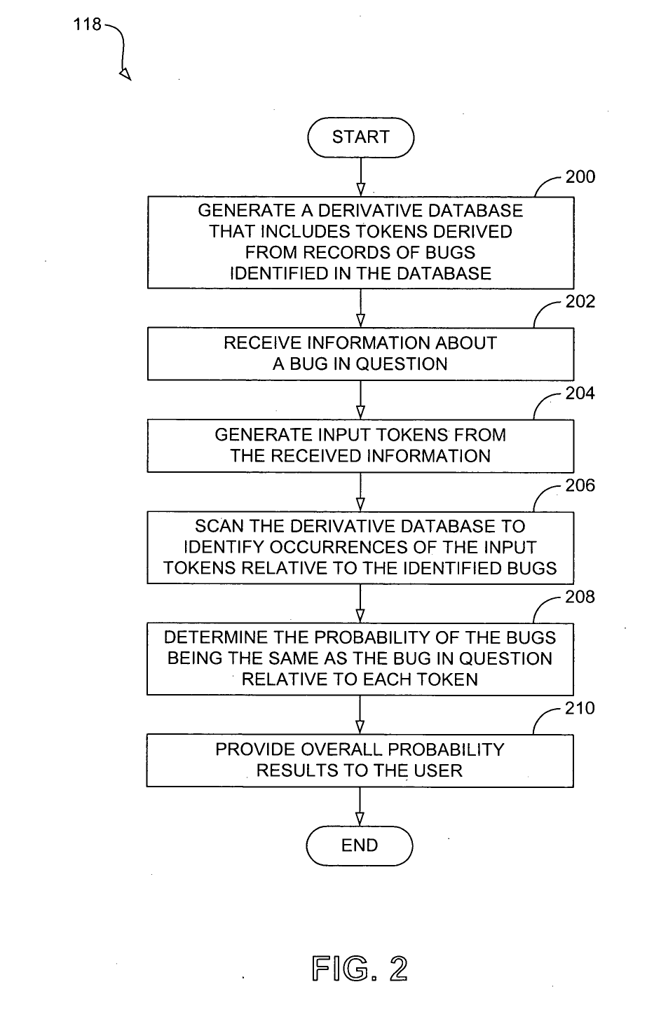

FIG. 2 provides an example method for identifying similar bugs. More particularly, FIG. 2 provides an example of operation of the bug similarity system 118 in aiding a user in making a determination as to whether a bug in question is new or whether it is a previously-identified bug (and if so which one). Beginning with block 200 of that figure, the bug similarity system 118 first generates a derivative database that includes tokens that are derived from records of bugs identified in the database. Once the derivative database has been generated, the system 118 can receive information about a bug in question, as indicated in block 202. More particularly, the system 118 receives information about a bug for which a determination is to be made as to whether the bug is new or has been previously identified. Using that received information, the system 118 then generates input tokens, as indicated in block 204, that are used in the bug identification process.

Once the input tokens have been generated, the bug similarity system 118 compares the input tokens, which describe the bug in question, with the tokens contained in the derivative database (see block 200). Accordingly, as indicated in block 206, the system 118 scans the derivative database to identify the occurrences of the input tokens in the derivative database relative to the associated bugs identified in the derivative database. In addition, the number of times the input tokens appear in the derivative database relative to those bugs is identified. Next, the system 118 determines the overall probability as to each bug in the derivative database being the same bug as the bug in question, as indicated in block 208, so that the user can make his or her own decision as to whether the bug is new or known. Once the probability determination is made, the system 118 can then provide the overall probability results to the user, as indicated in block 210, to give the user an indication of the most likely candidates for a match with the bug in question.

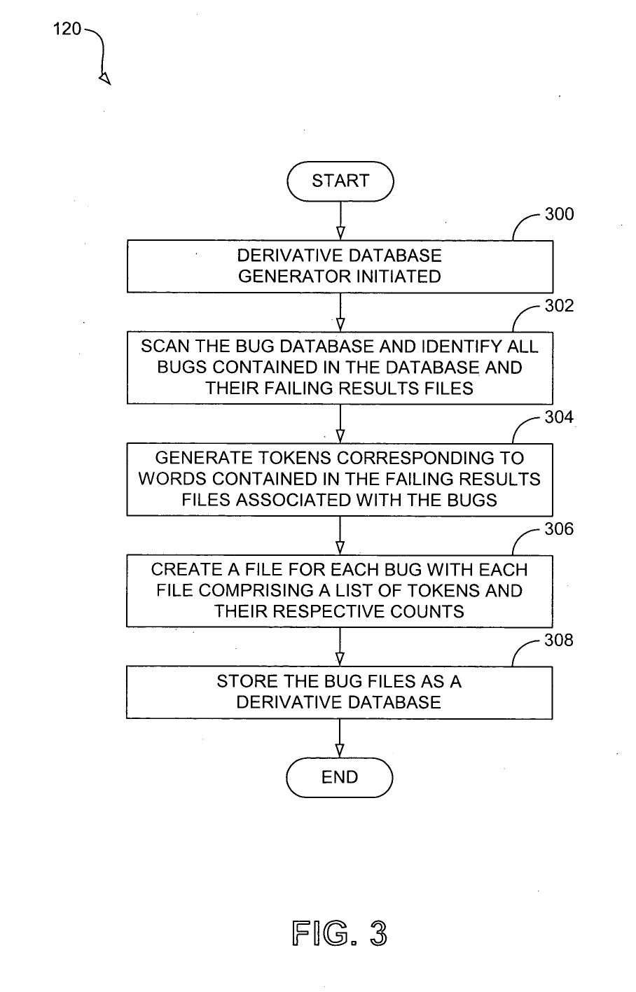

In view of the above, the bug identification and similarity determination begins with generation of a derivative database (e.g., database 124, FIG. 1). As described in relation to FIG. 1, the derivative database can be generated by the derivative database generator 120. FIG. 3 provides an example of operation of the derivative database generator 120 in generating such a derivative database. Beginning with block 300 of FIG. 3, the generator 120 is initiated. This initiation can be automatic or can occur in response to a command received from an operator. In the former case, initiation may occur on a periodic basis. For example, the derivative database generator 120 may operate each day, for instance at night after all new entries have been made into the associated bug database, so as to use the most current bug data in generating the derivative database.

Once the derivative database generator 120 is initiated, the generator scans the bug database at issue and identifies all bugs that are contained in the bug database, as well as each failing results file associated with those bugs, as indicated in block 302. As described above, the failing results files may be attached to entries in the bug records. Next, the derivative database generator 120 generates tokens for each bug that correspond to character strings contained in the failing results files associated with those bugs, as indicated in block 304. In an effort to only generate tokens for character strings (e.g., words) that are most relevant to the similarity determination, tokens may only be made for character strings that are proximate to the term “error,” or equivalent, contained in the failing results files. For example, a window comprising the character strings of the 10-20 lines that precede and follow each occurrence of the word “error” may be used to define groups of character strings for the purpose of generating the tokens. In some embodiments, the tokens further are only generated for “word-like” character strings to avoid creating tokens for miscellaneous keystrokes and/or commands that contribute little to the similarity determination. This may be accomplished by, for example, only generating tokens for character strings that comprise letters, numbers, and/or underscores. Such discrimination of the character strings results in filtering of spaces, tabs, periods, brackets, and the like that do not positively contribute to the analysis.

In addition to limiting the generation of tokens to such word-like character strings, tokens may not be generated for character strings that comprise less or more than predetermined thresholds of numbers of characters. For example, in some embodiments, character strings that comprise less than 3 characters or more than 20 characters are disregarded such that tokens are not generated for those character strings. This form of discrimination results in filtering of small words that are unlikely to contribute to the analysis (e.g., words like “a,” “an,” and “it”), as well as large “words” that merely comprise data strings generated by the bug database interface.

With reference next to block 306, the derivative database generator 120 creates a file, i.e., a bug file, for each bug that was identified in the bug database. For purposes of simplicity, the files can be given sequential, numerical names. Associated with each bug file are the various tokens that were generated for each respective bug that was identified. In addition, the number of appearances of each token relative to each bug is noted. Therefore, if a particular token appears at least once for a given bug, the count for that token/bug combination is increased to equal the total number of times the token appears for the bug. For example, if the token “vector” appears three times for bug A, the entry for that token in bug A's file may comprise “vector 3” or equivalent. Optionally, control can be exercised over incrementing of the counts to avoid skewing the probability determination. For instance, a maximum increment amount can be used so that the count number as to any one bug's token can only be increased by a limited amount. To cite an example, if the increment amount were capped at 20 and bug A had a first failing results file in which token A appeared 25 times and a second failing results file in which token A appeared 33 times, the count for token A only would be increased by 20 for each of the two failing results files.

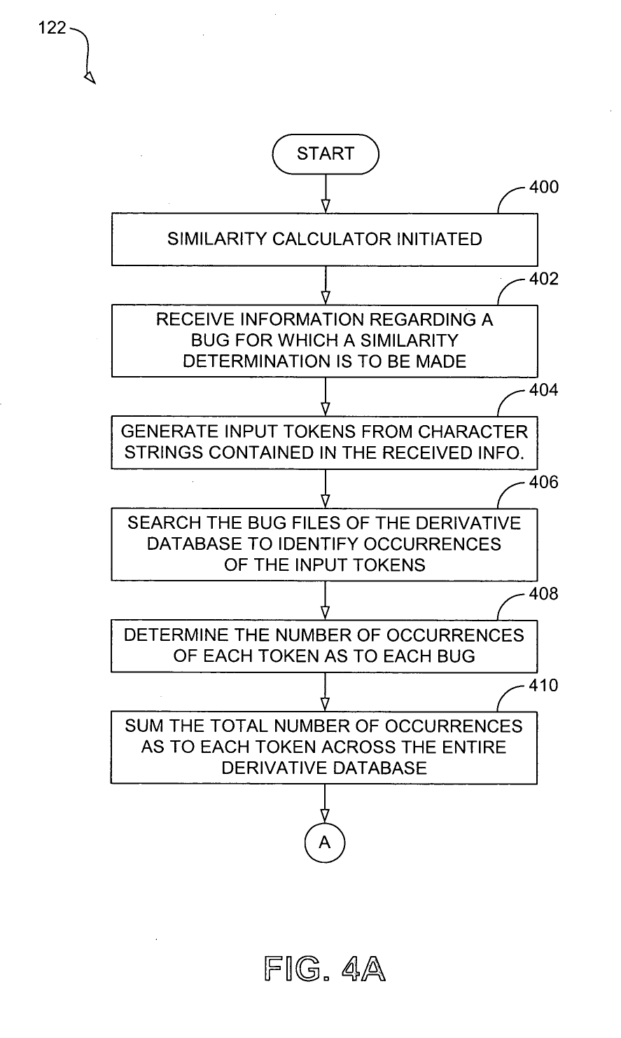

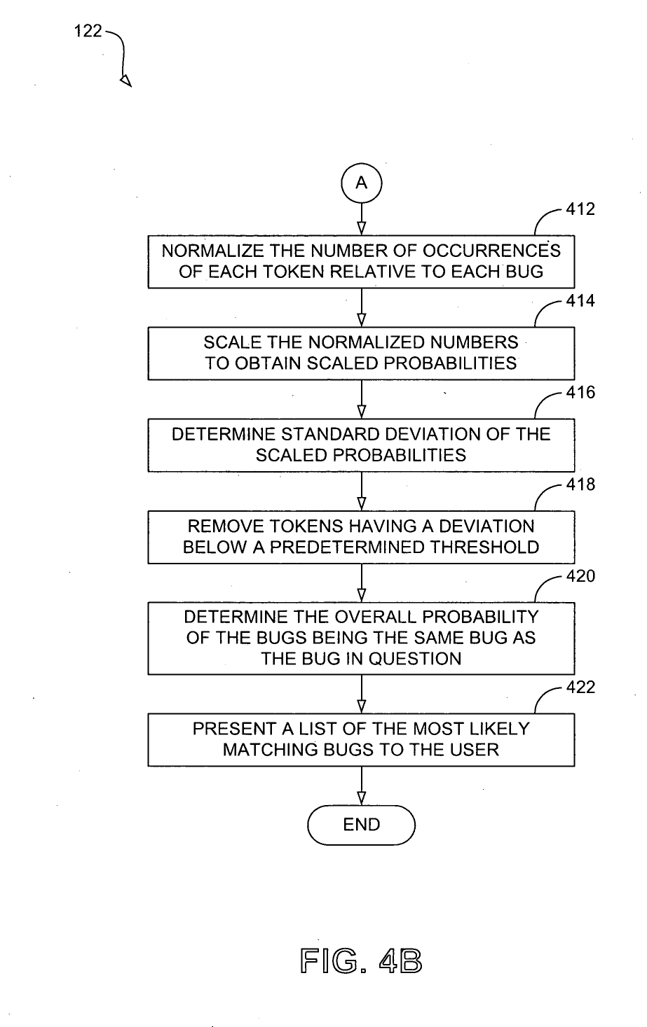

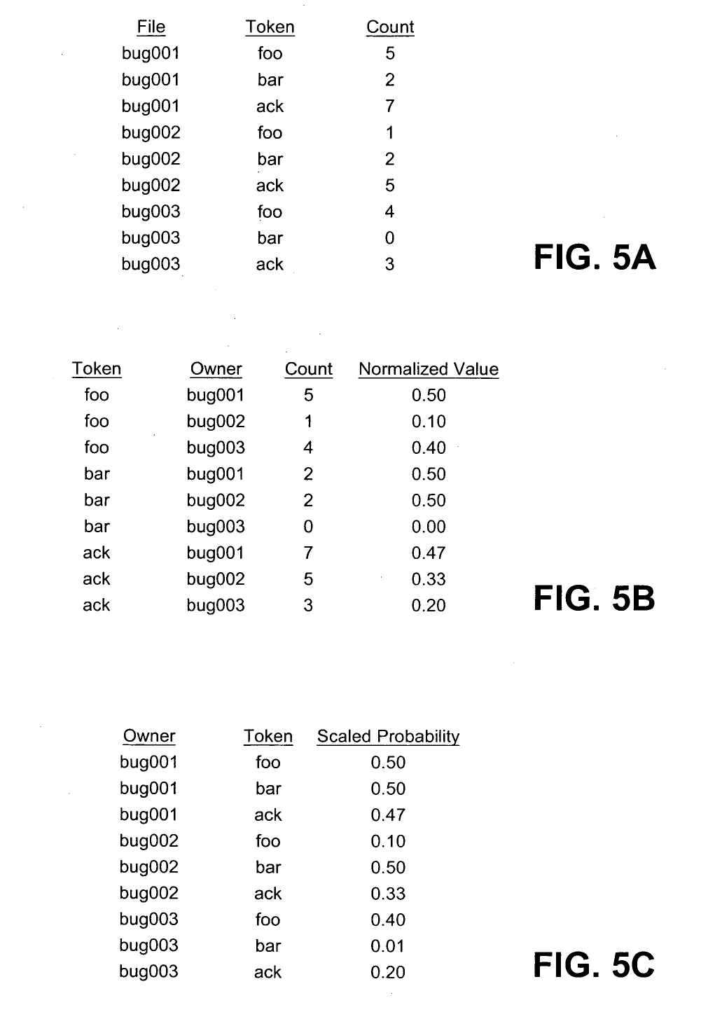

Once all bug files have been created, the derivative database generator 120 stores the bug files in a database, i.e., the derivative database (assuming the derivative database did not already exist), as indicated in block 308. At this point, the derivative database is available for use in making probability determinations as to the likelihood that the bugs of the derivative database are the same as the bug in question using the similarity calculator 122 (see FIGS. 4A and 4B). An example of the contents of a derivative database is conceptually illustrated by the table of FIG. 5A. As indicated in that table, three files, “bug001,” “bug002,” and “bug003” are included in the derivative database. In addition, the derivative database includes the number of occurrences for each of tokens “foo,” “bar,” and “ack,” as to each bug. For instance, the number of occurrences of the token “foo” for bug001 is 5. Notably, the actual configuration and structuring of the derivative database is unimportant. Generally speaking, the derivative database comprises an associative array that associates bugs with tokens and the number of occurrences of those tokens on a per-bug basis.

FIGS. 4A and 4B illustrate an example of operation of the similarity calculator 122 in providing an indication as to the probability as to previously-identified bugs of the derivative database being the same bug as the bug in question. Beginning with block 400 of FIG. 4A, the similarity calculator 122 is initiated. Such initiation typically occurs when the calculator 122 is called upon by a user to provide an indication as to the probability of a bug in question being a bug that is contained in the bug database. Once initiated, the similarity calculator 122 receives information regarding the bug in question, as indicated in block 402. By way of example, that information can comprise a failing results file for the bug in question. Irrespective of the origin of the information, the information is pertinent to the bug in question and therefore may be used as a reference (i.e., search query) in the determination.

With reference next to block 404, the similarity calculator 122 generates input tokens that are derived from the character stings of the information that was input into the calculator. In some embodiments, the input tokens are generated using the same rules that were used to generate the tokens contained in the derivative database (see the discussion of FIG. 3). Therefore, tokens may only be generated for strings of characters that are proximate to the term “error,” or equivalent, contained in the failing results files, that comprise letters, numbers, and/or underscores, and that are not shorter or longer than predetermined thresholds. Once the input tokens have been generated, the similarity calculator 122 searches the bug files of the derivative database to identify occurrences of the input tokens as to each bug, as indicated in block 406. From that identification, the similarity calculator 122 can further determine the number of occurrences of each token as to each bug, as indicated in block 408. That determination is made by simply reading the count contained in the derivative database as to each token.

Next, as indicated in block 410, the similarity calculator 122 sums the total number of occurrences as to each token across the entire derivative database. Such summing can be accomplished by simply adding together the counts as to each token for all bugs. In keeping with the example data contained in the table of FIG. 5A (which conceptually illustrates the contents of an example derivative database), the total counts for the three identified tokens are: foo=10, bar=4, and ack=15. Once those totals have been determined, the calculator 122 normalizes the number of occurrences of each token relative to each bug, as indicated in block 412 of FIG. 4B. Such normalization comprises dividing the total number of occurrences for each token as to each given bug by the total number of occurrences for the token across all bugs. The normalized values that result comprise probabilities as to the given bug being the bug in question relative to each individual token. FIG. 5B conceptually illustrates the results of the above-described normalization process on the data contained in the table of FIG. 5A. As indicated in FIG. 5B, the normalized values (i.e., probabilities) for bug001 as to each input token are: foo=0.50, bar=0.50 and ack=0.47; for bug002 are foo=0.10, bar=0.50, and ack=0.33; and for bug003 are foo=0.40, bar=0.00, and ack=0.20. To determine the overall probability, however, all tokens and all bugs must be taken into account (see discussion below).

Referring next to block 414, the normalized values (probabilities) are scaled to obtain scaled probabilities as to each token/bug pair. This scaling is performed to avoid skewing the overall probability determination. In this scaling, extremely low (near zero) and high (near one) normalized values are adjusted to reduce their impact on the overall probability determination. For instance, any normalized value that is less than 0.01 can be assigned a value of 0.01, and any normalized value that is greater than 0.99 can be assigned a value of 0.99. In addition, if any given input token is not found for any of the bugs (i.e., it is not contained in the derivative database at all), the normalized value for that token for each bug can be assigned a nearly neutral, but negatively-biased, value such as 0.40. Results of such scaling on the data of FIG. 5B are indicated in FIG. 5C. As shown in that figure, the “0.00” value for bug003 in relation to the “bar” function has been changed to “0.01” through application of the rules described above.

At this point, the similarity calculator 122 may determine the standard deviation of the scaled probabilities, as indicated in block 416, to potentially reduce the field of possible tokens to be considered for an bug in the overall probability determination. To determine the deviation, the absolute value of each scaled probability minus 0.50 is calculated. If the result of that calculation is less than a predetermined minimum deviation value, the token associated with the scaled probability may be removed from the list of tokens to be considered for the overall probability determination, as indicated in block 418. For instance, if the minimum deviation value were set to 0.10, each token having a probability value between 0.40 and 0.60 would be removed from consideration. Notably, for purposes of the present example and later overall probability calculation, none of the tokens for the three example bugs (bug001, bug002, and bug003) will be removed from the list of tokens to be considered (i.e., the minimum deviation equals zero).

With reference to block 420, the overall probability can next be determined as to each bug. Various different analytical and/or statistical tools can be used to make that determination. One such tool is Bayes' Theorem. Bayes' Theorem, as applied in this context, may be described as to each bug in equation form as the following:

$${P}_{O} = \frac{( product of scaled probabilities )}{\begin{matrix}( product of scaled probabilities ) + \\ ( product of inverse probabilities )\end{matrix}} \qquad [ Equation 1 ]$$

where Pₒ is the overall probability, the “scaled probabilities” are the scaled, normalized values, and the “inverse probabilities” are equal to the result of subtracting the scaled probabilities from 1 as to each bug. Applying that equation for each of the example bugs from FIGS. 5A-5C we obtain the following:

$$bug001 \text{:}$$

$${P}_{O} = ( 0.50 ) ( 0.50 ) ( 0.47 ) / ( ( 0.50 ) ( 0.50 ) ( 0.47 ) + ( 0.50 ) ( 0.50 ) ( 0.53 ) ) \\ = 0.4700$$

$$bug002 \text{:}$$

$${P}_{O} = ( 0.10 ) ( 0.50 ) ( 0.33 ) / ( ( 0.10 ) ( 0.50 ) ( 0.33 ) + ( 0.90 ) ( 0.50 ) ( 0.67 ) ) \\ = 0.0052$$

$$bug003 \text{:}$$

$${P}_{O} = ( 0.40 ) ( 0.01 ) ( 0.20 ) / ( ( 0.40 ) ( 0.01 ) ( 0.20 ) + ( 0.60 ) ( 0.99 ) ( 0.80 ) ) \\ = 0.0013$$

Once the overall probabilities, Pₒ, have been determined as to each bug, they can be presented to the user, for instance in a display device or as a print out. By way of example, a list of the most likely matches for the bug in question can be presented to the user, as indicated in block 422. Such a list can comprise, for instance, the top three to five bugs as ranked by the overall probabilities from largest to smallest. In the above example, it appears clear that bug001 is likely the same bug as the bug in question in that the overall probability number for that bug (0.4700) far exceeds those of the other two bugs. Although not all results will so obviously indicate the most likely matching bug, the results will at minimum provide an indication that the user can consider in making his or her own determination as to whether the bug in question is a new bug or a bug that has been previously identified. Therefore, the disclosed systems and methods may be considered tools available to users in searching for a match for bugs they have discovered.

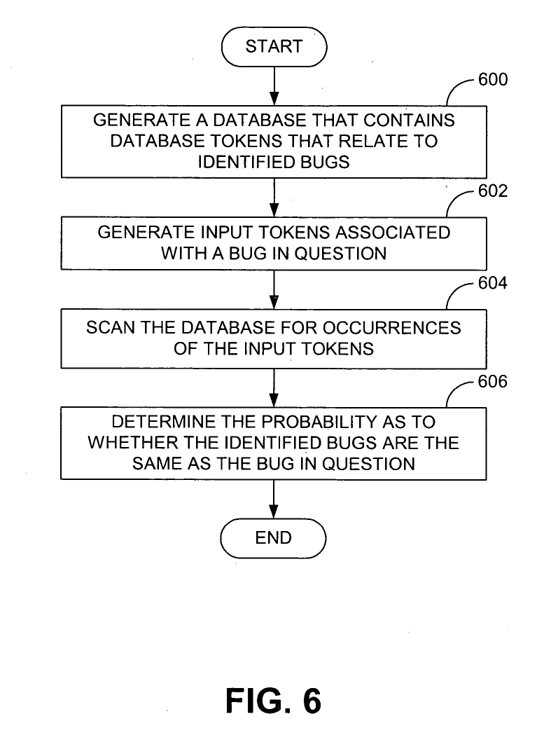

In view of the above, an embodiment for identifying similar bugs is shown in the flow diagram of FIG. 6. As provided in FIG. 6, that method comprises generating a database that contains database tokens that relate to identified bugs (block 600), generating input tokens associated with a bug in question (block 602), scanning the database for occurrences of the input tokens (block 604), and determining an overall probability as to whether the identified bugs are the same as the bug in question (block 606).

1. A method for identifying similar bugs, comprising:
generating a database that contains database tokens that relate to identified bugs;
generating input tokens associated with a bug in question;
scanning the database for occurrences of the input tokens; and
determining an overall probability as to whether the identified bugs are the same as the bug in question.

2. The method of claim 1, wherein generating a database comprises generating a derivative database from a bug database that contains failing results files.

3. The method of claim 2, wherein generating a derivative database comprises generating database tokens from character strings of the failing results files.

4. The method of claim 3, wherein generating database tokens comprises generating tokens for character strings that are proximate to the term “error” in the failing results files.

5. The method of claim 3, wherein generating database tokens comprises generating tokens for character strings that comprise at least one of letters, numbers, and underscores.

6. The method of claim 3, wherein generating database tokens further comprises noting the number of times each token occurs relative to each bug of the database.

7. The method of claim 1, wherein generating input tokens comprises generating tokens from character strings of an input failing results file of the bug in question.

8. The method of claim 1, wherein scanning the database comprises scanning the tokens of the database to identify matches for the input tokens.

9. The method of claim 1, wherein scanning the database further comprises identifying the number of occurrences of each input token in the database relative to each bug of the database.

10. The method of claim 1, wherein determining the overall probability comprises summing the total number of occurrences of each input token in the database and normalizing the total number of occurrences of each input token as to each bug of the database.

11. The method of claim 10, wherein determining the overall probability further comprises scaling normalized values that result from the normalizing to obtain scaled probabilities as to each input token relative to each bug of the database.

12. The method of claim 11, wherein determining the overall probability further comprises determining the standard deviance for each scaled probability and removing bug tokens from consideration that are associated with an input token having a deviance below a predetermined minimum deviance.

13. The method of claim 12, wherein determining the overall probability further comprises determining the overall probability as to all bugs using the scaled probabilities associated with those bugs.

14. The method of claim 13, wherein determining the overall probability as to all bugs comprises applying Bayes' Theorem to the scaled probabilities to calculate the overall probability for each bug as being the same bug as the bug in question.

15. A system for identifying similar bugs, comprising:
means for generating input tokens associated with a bug in question;
means for scanning a database that associates bugs with database tokens pertaining to bugs for occurrences of the input tokens; and
means for determining an overall probability for each bug of the database of being the same bug as the bug in question.

16. The system of claim 15, wherein the means for generating input tokens comprise means for generating tokens from character strings of an input failing results file for the bug in question.

17. The system of claim 15, wherein the means for scanning a database comprise means for scanning the database tokens to identify matches for the input tokens and means for identifying the number of occurrences of the input tokens in the database relative to each potential bug.

18. The system of claim 15, wherein the means for determining the overall probability comprise means for determining a probability that a bug is the same relative to each database token associated with the bug.

19. The system of claim 18, wherein the means for determining the overall probability further comprise means for applying Bayes' Theorem to those probabilities to calculate the overall probability for each bug as being the bug in question.

20. The system of claim 15, further comprising means for generating the database from failing results files contained in a bug database.

21. A system stored on a computer-readable medium, the system comprising:
logic configured to generate a database that associates bugs with tokens derived from failing results files of the bugs;
logic configured to generate input tokens from an input that describes a bug in question;
logic configured to identify the number of occurrences of each of the input tokens in the database as per each potential bug; and
logic configured to determine an overall probability of each bug being the same as the bug in question relative to the number of occurrences.

22. The system of claim 21, wherein the logic configured to generate input tokens is configured to generate tokens from character strings of an input failing results file.

23. The system of claim 21, wherein the logic configured to determine the overall probability is configured to determine probabilities as to each bug relative to database tokens associated-with those bugs.

24. The system of claim 23, wherein the logic configured to determine the overall probability is further configured to apply Bayes' Theorem to the determined probabilities to calculate the overall probability for each bug of being the bug in question.

25. A bug similarity system stored on a computer-readable medium, the system comprising:
a derivative database generator that is configured to generate a derivative database that contains a plurality of database tokens that are associated with identified bugs; and
an similarity calculator that is configured to:
generate input tokens from an input that describes a bug in question,
determine the number of occurrences of the input tokens in the derivative database relative to each bug,
determine the probability of each bug being the same bug as the bug in question relative to each input token, and
calculate an overall probability of each bug being the same bug as the bug in question using the determined probabilities.

26. The system of claim 25, wherein the derivative database generator is configured to generate the database tokens from character strings contained in failing results files of a bug database.

27. The system of claim 25, wherein the similarity calculator is configured to calculate the overall probability by applying Bayes' Theorem to the determined probabilities.

28. A computer system, comprising:
a processing device; and
a memory that comprises a bug similarity system, the bug similarity system being configured to generate a first set of tokens for each of several bugs, generate input tokens from an input that describes a bug in question, determine the number of occurrences of the input tokens in the first sets of tokens, determine the probability as to each of the bugs of whether each bug is the same bug as the bug in question relative to each input token, and calculate an overall probability as to whether the bugs are the same bug as the bug in question using the determined probabilities.

29. The system of claim 28, wherein the bug similarity system is configured to calculate the overall probability by applying Bayes' Theorem to the determined probabilities.
